(19) United States
(12) Patent Application Publication
(10) Pub. No.: US 2024/0358200 A1
(43) Pub. Date: Oct. 31, 2024

(54) COLLAPSIBLE DEVICE CHARACTERIZED WITH CHANGEABLE LENGTH FOR STORING SLICED FOOD

(71) Applicant: Sharon SHERMAN, Holon (IL)

(72) Inventor: Sharon SHERMAN, Holon (IL)

(21) Appl. No.: 18/577,262

(22) PCT Filed: Jul. 20, 2022
(86) PCT No.: PCT/IL2022/050784

§ 371 Date: Jan. 7, 2024

(30) Foreign Application Priority Data
Jul. 21, 2021 (IL) 285022

(51) Int. Cl. A47J 47/12; A47J 47/10

(52) U.S. Cl. CPC A47J 47/12; A47J 47/10

(57) ABSTRACT

Disclosed herein is a device, for storing frozen bread slices in a closed manner. In some embodiments the device comprises, a collapsible container formed to stand upright having a substantially rectangular cross-section with walls extending longitudinally therethrough. The container is characterized by two or more slice-compartments located inside the container and standing upright along the container, the slice-compartments are open at the top-ends thereof for accepting the bread slices. The device also employs a collapsible lid mounted to the container and adapted to open and close the container thereby to close the container in case the container is in closed state. The container is also adapted to collapse inwardly where the resistance of the bread slices in the slice compartments forces the compartments not containing bread slices to fold in, thereby to determine the length of the device according to the number of bread slices stored therein.

### FIELD OF THE INVENTION

The invention relates generally to the field of food storage devices. More specifically, the present invention relates to devices for food storage in low temperature.

### BACKGROUND

Sliced bread is usually sold in thin flexible paper bags or polyethylene envelopes that separate the bread from the external environment. Unless all the slices of bread are consumed shortly after opening the package, it is usually necessary to keep and store the remaining slices.

Current devices designed to store the remaining slices has difficulties of protecting the slices from coming into contact with environmental pollutants, humidity and varying temperatures.

Furthermore, a bread storage providing for frequent opening and reclosure of the flexible envelope containing the bread slices in a convenient and simple fashion, is a requirement which bread storage devices are required to meet, in addition to the need of protecting the bread slices.

One of the options seen today is storing the bread slices in a container with simple and convenient access. Yet, consuming individual slices as needed, while maintaining the remaining slices protected, in convenient and stable manner are basic issues remain to resolve in existing devices.

The foregoing examples of the related art and limitations related therewith are intended to be illustrative and not exclusive. Other limitations of the related art will become apparent to those of skill in the art upon a reading of the specification and a study of the figures.

### SUMMARY

In one aspect of the subject matter disclosed herein, there is a device for storing bread slices, wherein the disclosed device can comprise: a collapsible container formed to stand upright having a closed bottom surface and open top end, said container has a substantially rectangular cross-section with walls extending longitudinally therethrough; wherein said container is characterized by two or more slice-compartments located inside the container and standing upright along the container, said slice-compartments are open at the top-ends thereof for accepting the bread slices; a collapsible lid mounted to said container adapted to open and close the container thereby to maintain the device in a firmed and stable shape in case said lid is closed; and said container is adapted to collapse inwardly where the resistance of the bread slices in the slice compartments forces the compartments not containing bread slices to fold in thereby to determine the length of the device according to the number of bread slices stored therein

In one aspect of the disclosed subject matter, the lid is adapted to seal the container in case the lid is closed.

In one aspect of the disclosed subject matter, the disclosed device employs a fastening strip stretches along the device and adapted to band together the lid and the container in a sealed manner.

In one aspect of the disclosed subject matter, the fastening strip is an elastic strip designed to exert force on the lid thereby to maintain said device in a sealed manner.

In one aspect of the disclosed subject matter, the device is collapsed, the number of bread slices determines the length of the device.

In one aspect of the disclosed subject matter, the sealing of the container prevents, at least partially, an ingress of gas, moisture, fluid or ice into the container.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale.

The figures are listed below:

FIG. 1A shows a device comprising a collapsible container and a lid in an open state, according to exemplary embodiments of the disclosed subject matter;

FIG. 1B shows an enlarged view of a portion of a device comprising a collapsible container and a lid, according to exemplary embodiments of the disclosed subject matter;

FIG. 2A shows a device for storing frozen bread slices, in a closed state, according to exemplary embodiments of the disclosed subject matter;

FIG. 2B shows a device for storing frozen bread slices, collapsed in a closed state, according to exemplary embodiments of the disclosed subject matter;

FIG. 3 shows an upper view of a device for a device for storing bread slices, according to exemplary embodiments of the disclosed subject matter;

FIG. 4 shows a device for storing bread slices with a rectangular lid, according to exemplary embodiments of the disclosed subject matter;

FIG. 5 shows a device comprising a collapsible container and a lid in an open state and bread slices inserted thereto, according to exemplary embodiments of the disclosed subject matter, and;

FIG. 6 showing an upper view of a device comprising a collapsible container and a lid in an open state and bread slices inserted thereto, according to exemplary embodiments of the disclosed subject matter.

### DETAILED DESCRIPTION

Disclosed herein is a device, for storing frozen bread slices in a closed manner, comprising a collapsible container adapted to collapse according to the number of bread slices stored therein.

The term “bread slice” used herein, refers to slices of food. These slices of food can be sliced bread, cookies, any slices of pastry, biscuits, slice of meat, slices of vegetable, or any food which can be stored and consumed in pieces. The term bread slice used herein for convenience purposes only. Hence, in some embodiments, the present disclosure provides for storing food sliced or cut from a larger portion.

In some embodiments, the present disclosure provides for storing the bread slices wherein each of the bread slice is stored in a slice compartment. Exemplary embodiments of the present disclosure are provided with series of compartments each of which is shaped to house a separated bread slice, e.g., rectangular compartments adapted to house bread slices.

In some embodiments, the slice compartments are located inside the container and standing upright along the container, in some embodiments, the slice-compartments are open at the top-ends thereof for accepting the bread slices.

In some embodiments, the container defines a bread slice receiving space adapted to receive each bread slice individually.

In some embodiments, the container is characterized at least two slice-compartments located inside the container and standing upright along the container.

In some embodiments, the container a lid is mounted to the container for the purpose of closing the container at the upper ends thereof. In some embodiments, the device can be in an open state, such that the lid is open and the top-ends of the slice-compartments are open to receive bread slices. Thus, in some embodiments, the container can be in a closed state such that the container and the slice compartments thereof are blocked by the closed lid.

In some embodiments, the present disclosure provides for sealing the container and to prevent ingress of moisture, odor, fluids, and/or gasses into the container. In some embodiments, the lid prevents from exchanging of air between the air within the container and the air outside of the container.

In some embodiments, the present disclosure provides for adapting the length of the device in accordance with the number of the bread slices sored therein. Thus, in some embodiments, the container is a collapsible container for the purposes reducing the length of the device while maintaining the opacity of the container.

In some embodiments, the lid mounted to the container is also a collapsible lid preventing an ingress of gas, or moisture in to the container.

In some embodiments, the bread slices can be inserted into the slice-compartments where the bread slices are not frozen, e.g., in the ambient temperature, the lid can be closed and the device can be collapsed wherein the bread slices are not frozen.

In some embodiments, the present disclosure provides for storing the bread slices non-frozen state.

The present disclosure is not limited to the embodiments described above, but it can be realized, modified and indicated in examples described further below.

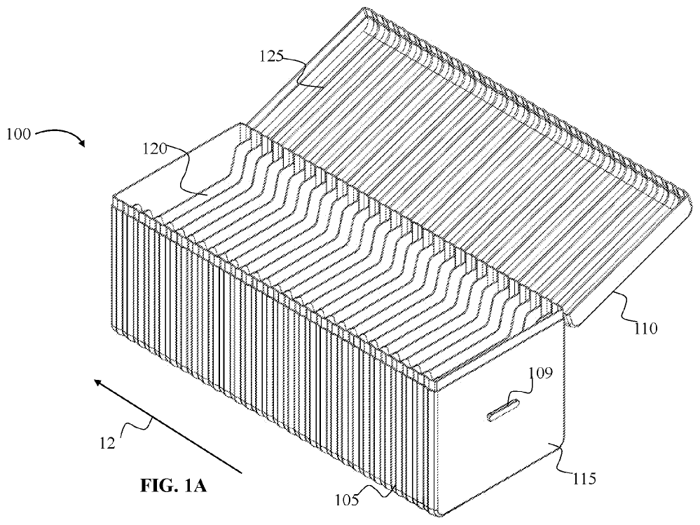

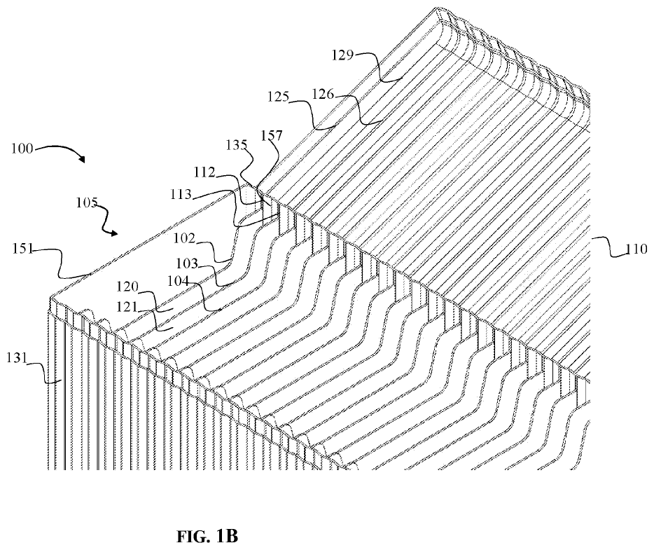

A reference is made to FIG. 1A showing a device comprising a collapsible container and a lid in an open state, according to exemplary embodiments of the disclosed subject matter. FIG. 1A depicts a device 100 designed for storing frozen bread slices in a closed manner. Device 100 comprises a collapsible container 105 characterized by more than one slice-compartments located inside the collapsible container 105, such as slice-compartment 120. In some embodiments, the collapsible container 105 defines a bread slice receiving space with changeable length.

In some embodiments, such a receiving space with changeable length defined by the container 105 can receive one bread slice or multiple (e.g., more than one) bread slices. In some embodiments, the collapsible container 105 is adapted to easily form a device 100 with a stable shape, in each size of the container 105.

The slice-compartments are standing upright along the container, wherein the slice-compartments are open at the top-ends thereof for accepting the bread slices. Device 100 also comprises a lid 110 adapted to enclose the collapsible container 105 from above thereby to deal the container 105.

In some embodiments, the device 100 is a collapsible device actuatable gradually between a collapsed position and an expanded position. In some embodiments, device 100 is adapted to collapse in an accordion-like fashion wherein each slice-compartment exerts pressure on the adjacent slice-compartment thereof. In some embodiments, the accordion-like shape, allowing the device 100 to occupy substantially less length than a fully expanded device.

In some embodiments, the present disclosure provides for collapsing the device 100 is by exerting external force on at least one of the walls of the container 105, e.g., container wall 115, according to the direction pointed by arrow 12. In some embodiments, such a force provides for changing the length of device 100, wherein the length of device 100 is shown by arrow 12.

In some embodiments, each of the slice-compartments, such as slice-compartment 120 is shaped to house a bread slice. In some embodiments, the slice-compartments of device 100 are collapsible slice-compartments, wherein each slice-compartment can collapse independently, namely without any mechanical dependence on the other slice-compartments.

In some embodiments, in cases where a bread slice is located within a slice-compartment the resistance of the bread slices can prevent from the slice-compartments comprising bread slices to collapse. Thus, each slice-compartment comprising a bread slice can transfer the pressure exerted thereof to the adjacent slice-compartment.

Accordingly, in some embodiments, exerting pressure on the container 105 causes the slice-compartments comprising bread slices to remain expanded (i.e., not in a collapsed position) and the slice-compartments not comprising bread-slices, to collapse. Thus, the number of bread slices determines the length of the device 100.

In some embodiments, device 100 employs the lid 110 for sealing the container 105. In some embodiments, such a sealing prevents, at least partially ingress of fluid, moisture, or ice into the container 105.

In some embodiments, the lid 110 is a collapsible lid with closing stripes such as closing stripe 125. In some embodiments, the closing stripes are relatively rigids such that each closing stripe can contact with a corresponding wall of a corresponding slice-compartment. Thus, in some embodiments, in the closed state of the lid 110 the closing stripes and the slice-compartments form enclosed compartments designed for housing bread slices, as elaborated further below.

Device 100 also comprises fastening handle 109 attached to the container wall 115. In some embodiments, the fastening handle 109 can be used to push the container wall 115 toward the direction pointed by arrow 12, thus to collapse the device 100 to a collapsed position, or to pull the container wall 115 to the opposite direction pointed by arrow 12 thereby to expand the device 100.

In some embodiments, the fastening handle 109 can be used to prevent the device 100 from expanding and maintain the collapsed position of the device 100, as elaborated further below.

The depictions, description, and terms such as “exerting force” on the container 105 assume a normal force exerted by a person in a kitchen activity. Also, the term “relatively rigid” is relative to the force a person exerts in kitchen activities. Each term, description and/or depictions used hereafter is used under the assumption of a use as normal and standard kitchen activity by a person.

A reference is made to FIG. 1B showing an enlarged view of a portion of a device comprising a collapsible container and a lid, according to exemplary embodiments of the disclosed subject matter. FIG. 1B depicts a device 100 designed for storing frozen bread slices. Device 100 comprises a collapsible container 105 characterized by more than one slice-compartments located inside the collapsible container 105, such as slice-compartment 120 and slide compartment 121.

Device 100 comprises multiple partitions forming the slice-compartments adapted to house the bread slices. The partitions are positioned upright along the container, namely vertically to the ground, thereby forming slice-compartments which are positioned in parallel to the wall container 151 and perpendicular to wall container 135 and 131.

For example, slice-compartment 120 is formed by partitions 102 and 103 and slice-compartment 121 is formed by partitions 103 and 104. The slice-compartments of device 100 can be relatively rigid and be connected to the container walls by the partition slots. For example, the partitions 102 can be inserted into partition slot 112 located on container wall 135 and partitions 103 can be inserted into partition slot 113 also located on container all 135. In some embodiments, partition 102 and partition 103 can be inserted into corresponding slots (not shown) positioned on container wall 131.

In some embodiments, the partitions of the device 100, e.g., partitions 103 and 104, provide for preventing the adhesion or the attachment of adjacent bread slices one to each other. In some embodiments, preventing adjacent bread slices from their adhesion or from their attachment one to each other, allows taking out each bread slice separately.

In some cases, adhesion or attachment of two slices of bread is caused due to freezing process the bread slices undergo.

In some embodiments, the present disclosure provides for preventing the adhesion or attachment of adjacent bread slices, hence keeping the bread slices not attached, keeps the wholeness of the bread slices. In some cases, separating attached bread slices causes to breaking of the slice. Thus, this is the intention of the inventor to provide, in some cases, a device preventing sticking and/or breaking of the slices. In some embodiments, the material connecting between the partition slots, such as partition slots 112, and 113, can be a foldable material allowing the compress the container wall 135 to collapse. For example, the material portion 157 connecting between the partition slots 112, and 113 can be any foldable material such silicon, fabric, plastic, and the like.

In some embodiments, the device 100 and/or any of the components thereof can be formed of a stretchable such as fabric, plastic, silicon, nylon, or any polymer-based material exhibiting shape-memory effects. In some embodiments, the shape-memory effects contribute to the ability to return from a deformed state, e.g., wherein the device 100 is collapsed, to their original shape, e.g., wherein the device 100 is expanded and ready to receive bread slices.

In some embodiments, the device 100 and/or any of the components thereof the composition exhibits shape memory effects in temperature of between −10° C. and 50° C.

Device 100 employs a lid 110 formed and made of the collapsible material characterized by essentially same attributes as the container 105. In some embodiments, the lid 110 comprises closing stripes such as closing stripes 125 and 126. The closing stripes are connected with a lid connecting portions such as lid connecting portion 129 connecting between closing stripes 125 and 126. In some embodiments, such lid connecting portions are functioning the connective material between the closing stripes and the partitions, e.g., partition 103.

In some embodiments, the lid connecting portion 129 can be a foldable material allowing the compress the lid 110 to collapse. For example, the lid connecting portion 129 connecting between the closing stripes 125 and 126 can be any foldable material such silicon, fabric, plastic, and the like.

In some embodiments, the lid 110 can collapse at the same rate as the container 105. In some embodiments, the collation rate is the length shortage of the device 100 per the amount of force exerted on the device 100.

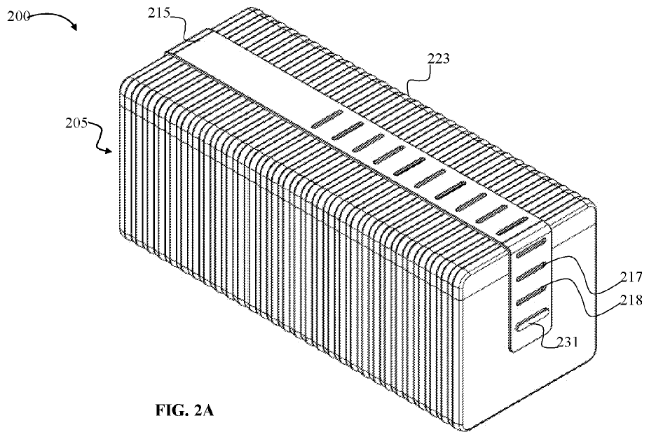

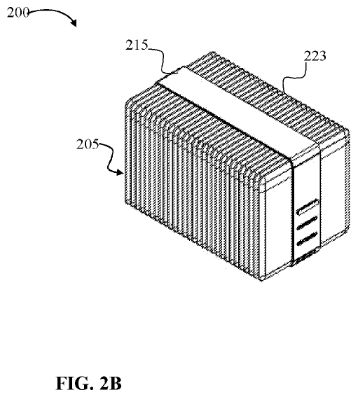

A reference is made to FIG. 2A showing a device for storing frozen bread slices, in a closed state, according to exemplary embodiments of the disclosed subject matter. FIG. 2A shows a device 200 adapted for storing slices of bread, where each of the bread slice is stored separately in a dedicate slice-compartment. Device 200 is a collapsible device, with the attributes of collapsing gradually, where each slice-compartment not containing a bread slice can collapse. Thus, the length of the device 200 in the collapsed position thereof is determined by the number of bread slices stored in the device.

In some embodiments, device 200 can collapse wherein the bread slices therein are not in a frozen state, in some embodiments, device 200 can collapse wherein the bread slices therein are in a frozen state.

Device 200 comprises a container 205 which is a bread receiving container defining a receiving space. Container 205 comprising the slice-compartments (not shown). Container 205 can be closed by a container lid 223 designed to collapse along with the container 205. In some embodiments, the container 205 and the container lid 223 can collapse by a pressure being exerted on the container 205, e.g., by a person pushing or shrinking the container as aforementioned.

Device 200 also comprising a fastening strip 215 adapted to fastening the container lid 223 to the container 205 thus, to band together the container 205 and the container lid 223. The fastening strip 215 comprises one or more fastening grooves such as fastening grooves 217 and 218. In some embodiments, the fastening grooves are adapted to receive the fastening handle 231 threaded therein such as a prong of a buckle in the belt hole.

In some embodiments, the fastening strip 215 can be used to assist forming a stable device 200 in each size of the device 200. Hence, device 200 provides for receiving a stable shaped device, wherein the size of the device 200 is changeable. Hence device 200 is stable and firmed device in any size thereof.

The firmness of the device can be defined by the ability to hold the device in one side, wherein the device 200 is closed, while the device 200 stays in one shape easy to carry and bear.

In some embodiments, the fastening handle 231 can be narrow and elongated strip adapted be inserted into one of the fastening grooves such as fastening grooves 217 or 218.

In some embodiments, the fastening strip 215 is an elastic strip utilized such as a rubber band for the purpose of achieving the required enclosing in accordance with the particular of the device 200. In some embodiments, the size of the device 200 is determined by the number of the bread slices. Thus, in some embodiments, the fastening strip 215 is an elastic stretchable strip adapted to store mechanical energy when being stretched from the resting position of the fastening strip 215.

In some embodiments, the fastening strip 215 can be stretched, fastened by inserting the fastening handle 231 to one of the fastening grooves (e.g., fastening grooves 217 or 218). In some embodiments, fastening the stretched fastening strip 215 to one of the fastening grooves maintains the tension of the stretched fastening strip 215.

Accordingly, in some embodiments, the tension of the stretched fastening strip 215 exerts an opposing force approximately proportional to its change in length of the stretched fastening strip 215. In some embodiments, this force maintains the length of the collapsed device 200. In some embodiments, the tension of the stretched fastening strip 215 bands together the container 205 and the container lid 223 in a sealed manner.

In some embodiments, the fastening strip 215 is made of rubber, silicon, latex, or any elastic polymeric substance. In some embodiments, the fastening strip 215 made of organic compound, synthetic compounds or a mix of synthetic and organic compounds.

A reference is made to FIG. 2B showing a device for storing frozen bread slices, collapsed in a closed state, according to exemplary embodiments of the disclosed subject matter. FIG. 2B shows a device 200 adapted for storing slices of bread, where each of the bread slice is stored separately in a dedicate slice-compartment.

Device 200 comprises is held compressed and/or collapsed by the fastening strip 215 which exerts force on the lid 223. In some embodiments, the exerted force on the lid 223 assists to maintain the lid 223 and the container 205 closed. In some embodiments, the exerted force on the lid 223 assists to maintain the lid 223 and the container 205 sealed.

In some embodiments, the device 200 can be inserted into a cupboard, closet or refrigerator adapted to maintain a temperature which is lower than the ambient temperature and used to store food and/or drinks.

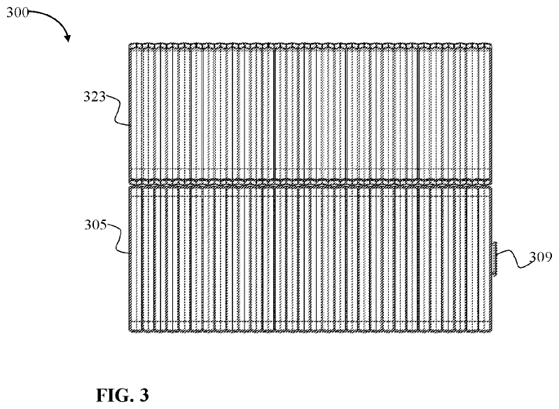

A reference is made to FIG. 3 showing an upper view of a device for storing bread slices, according to exemplary embodiments of the disclosed subject matter. FIG. 3 shows an upper view of a device 300 designed for storing bread slices. In some embodiments, the slices are frozen. Device 300 is an expanded position and in an open state. Device 300 employs a collapsible container 305 for storing the bread slices and a collapsible lid 323. In some embodiments, the collapsible lid 323 is adapted to fold toward the open top-end of the container 305 thereby to put the device in a close state.

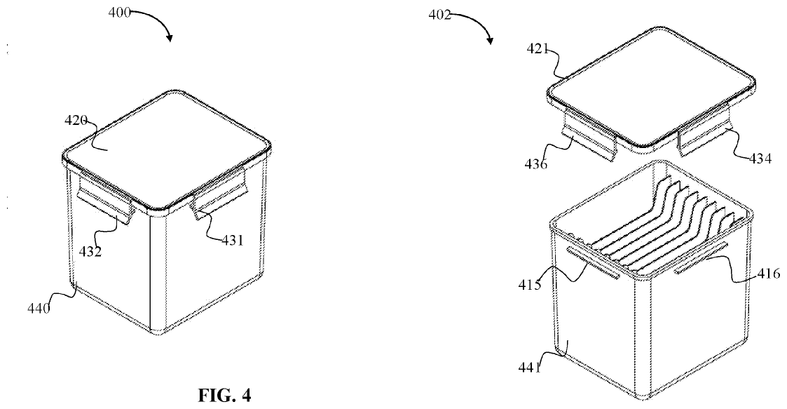

A reference is made to FIG. 4 showing a device for storing bread slices with a rectangular lid, according to exemplary embodiments of the disclosed subject matter.

FIG. 4 shows a rectangular device 400 for storing bread slices in a closed manner. Device 400 comprises a container 440 defining a receiving space and lid 420. In some embodiments, the device 400 and at least some of the components thereof are formed by injection-molding of plastic. Such a formation allows receiving a formed and firmed shape of the device 400.

The lid 420 comprises locking wings 431 and 432 allowing to close the lid 420 by mounting the lid 420 to the container 440.

FIG. 4 also shows a device 402 which is a collapsed view of a device adapted for storing bread slices in a closed manner. Device 402 comprises lid 421 comprises locking wings 436 and 434 allowing to close the lid 421 by mounting the lid 421 to the container 441.

In some embodiments, Container 441 comprises more locking wings such as 436 and 434 (not shown) adjoining to walls of container 441. Container 441 also comprises at least one flange portion such as flange portions 415 and 416. In some embodiments, the flange portions container 441 have the shape of a band and are located on outer surfaces of the side walls of container 441, such that the locking wings 436 and 434 can be engaged with the flange portions 415 and 416 to be maintained in a locked state.

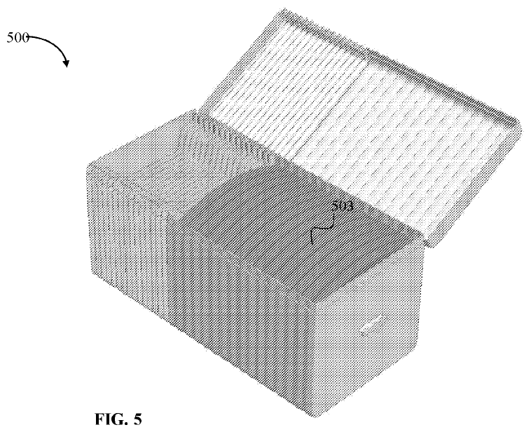

Reference is made to FIG. 5 showing a device comprising a collapsible container and a lid in an open state and bread slices inserted thereto, according to exemplary embodiments of the disclosed subject matter. FIG. 5 shows a device 500 with bread slices 503 inserted there to. In some embodiments, the device 500 and the components thereof can collapse such that the slice-compartments which do not comprise bread slices collapse while the slice-compartments comprising bread slices do not collapse.

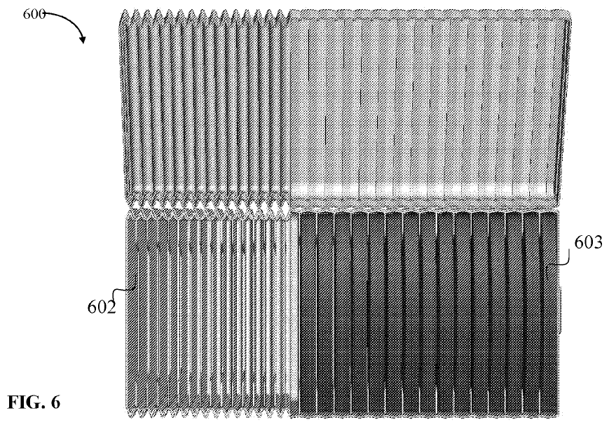

Reference is made to FIG. 6 showing an upper view of a device comprising a collapsible container and a lid in an open state and bread slices inserted thereto, according to exemplary embodiments of the disclosed subject matter. FIG. 6 shows a device 600 with bread slices 603 inserted there to. In some embodiments, the device 600 and the components thereof can collapse such that the slice-compartments which do not comprise bread slices 602 collapse while the slice-compartments comprising bread slices do not collapse.

1. A device for storing bread slices, comprising:
a collapsible container formed to stand upright having a closed bottom surface and open top end, said container has a substantially rectangular cross-section with walls extending longitudinally therethrough;
wherein said container is characterized by two or more slice-compartments located inside the container and standing upright along the container, said slice-compartments are open at the top-ends thereof for accepting the bread slices;
a collapsible lid mounted to said container adapted to open and close the container thereby to maintain the device in a firmed and stable shape in case where said lid is closed;
and
said container is adapted to collapse inwardly where the resistance of the bread slices in the slice compartments forces the compartments not containing bread slices to fold in thereby to determine the length of the device according to the number of bread slices stored therein

2. The device in claim 1, wherein the lid is adapted to seal the container in case the lid is closed.

3. The device in claim 1, employs a fastening strip stretches along the device and adapted to band together the lid and the container in a sealed manner.

4. The device in claim 3, wherein the fastening strip is an elastic strip designed to exert force on the lid thereby to maintain said device in a sealed manner.

5. The device of claim 1, wherein said device is collapsed, the number of bread slices determines the length of the device.

6. The device of claim 1, wherein said sealing prevents, at least partially, an ingress of gas, moisture, or ice into the container.

7. The device of claim 1, wherein
said slice compartments prevent the sticking of adjacent bread slices.
